(19) United States
(12) Patent Application Publication
(10) Pub. No.: US 2019/0343070 A1
(43) Pub. Date: Nov. 14, 2019

(54) IMMOVABLE PET BOWL AND A METHOD OF FABRICATING THEREOF

(71) Applicant: Ashish PADIA, Delhi (IN)

(72) Inventor: Ashish PADIA, Delhi (IN)

(21) Appl. No.: 15/570,862

(22) PCT Filed: Jul. 6, 2017
(86) PCT No.: PCT/IN2017/050274

§ 371 Date: Oct. 31, 2017

(30) Foreign Application Priority Data
May 15, 2017 (IN) 201711016880

(51) Int. Cl. A01K 5/01; A01K 7/00; B29C 65/70; B29C 65/00; B29C 65/48; B21D 22/02; B21D 51/18

(52) U.S. Cl. CPC A01K 5/0135; A01K 7/005; B29C 65/70; B29L 2031/7132; B29C 65/48; B21D 22/02; B21D 51/18; B29C 66/74283

(57) ABSTRACT

A pet food bowl may include a body having a medial portion with an upper end defining a first cavity for receiving food or water, and a lower end opposite the upper end, and an outer wall extending from the upper end of the medial portion at a periphery of the upper end of the medial portion. The pet food bowl may include a flexible annular flange coupled to a distal end of the outer wall along an entire length of the outer wall. The body may have a metallic material, and the lower end of the medial portion and the outer wall may define a second cavity opposite the first cavity. The flexible annular flange may be configured to define a suction cup with the second cavity for adhering the body to a surface.

### RELATED APPLICATION

This application is based upon prior filed copending international patent application No. PCT/IN2017/050274 filed Jul. 6, 2017, which claims priority to Indian patent application No. 201711016880 filed May 15, 2017, the entire subject matter of these applications is incorporated herein by reference in its entirety.

### TECHNICAL FIELD

The present disclosure relates to the field of pet accessories, and, more particularly, to a pet food bowls and related methods.

### BACKGROUND

Bowls for holding food or water for pets such as dogs are well known, and typically the bowls are formed of a side wall adapted to be rested onto a kitchen floor or the like with an interior dished portion for holding food or water. In use, the pet will place his muzzle in the dished portion and often cause the bowl to slide along the floor.

Reference is made to U.S. Pat. No. 9,624,963, dated Apr. 18, 2017, titled “Vacuum suction cup having bowl-shaped framework”, by ZHONGSHAN TAILI HOUSEHOLD PRODUCTS MANUFACTURING CO., LTD., China. This invention relates to a suction cup, including a bowl-shaped framework, a cup body covering the framework, a connecting rod on a back surface of the framework and passing through the cup body, a bowl-shaped cup cover placed on the connection rod and covering the back surface of the cup body, and an annular protruding rib placed on the periphery of the back surface of the framework, which is in direct contact with the inner surface of the cup cover for effectively transfer the pressing force to make the suction cup less likely to fall off from the supporting surface.

Another reference is made to U.S. Pat. No. 8,231,089, dated Jul. 31, 2012, titled “Suction plate or bowl holder”, by Lii Diner. This invention provides a plate holder, which includes: a skirt having a top member and one or more side walls forming a cavity therebetween when the one or more side walls are resting on a substrate with the top member oriented away from the substrate; a base coupled with the skirt and located within the cavity, the base having one or more top suction device receptacles and one or more bottom suction device receptacles; one or more top suction devices coupled with the one or more top suction device receptacles such that the top suction device is oriented away from the substrate; and one or more bottom suction devices coupled with the one or more top suction device receptacles such that the bottom suction device is oriented toward the substrate.

A further refernece is made to U.S. Pat. No. 6,581,541, dated Jun. 24, 2003, titled “Pet bowl with suction cup” by E&B Giftware LLC. This invention provides a pet bowl having an interior dished portion for receiving pet food, water or the like has a rather large suction cup held centrally to the underside of the pet bowl for securing the bowl to a surface such as a floor. The suction cup underlies at least a major portion of the lateral extent of the dished portion of the bowl, and may be held removably to the pet bowl by a bracket. The surface of the suction cup preferably has upstanding portions to engage the under-surface of the bracket to depress the suction cup assuredly upon downward movement of the bowl. The bracket may have a keyed opening, and a knob with an enlarged end extends upwardly from the suction cup and may be fitted within the keyed opening to hold the suction cup removably to the bracket. Further, a tab may extend from the rim portion of the suction cup to be accessed through an opening in the sidewall of the pet bowl for enabling the rim of the suction cup to be lifted and release the suction cup from the floor.

Another reference is made to CN204427465, titled “Bowl with suction disc” by FOSHAN DAOGE TECHNOLOGY CO LTD. The invention discloses a bowl with a suction disc. The bowl comprises a bowl body and the suction disc, wherein the suction disc is arranged at the bottom of the bowl body, and a disc mouth is downward; the bottom center of the bowl body is superposed with the center of the suction disc; the diameter of the bowl body is larger than that of the suction disc; the bowl body is made of silica gel; the suction disc is also made of silica gel; the bowl body and the suction disc are integrally formed. According to the bowl with the suction disc, the bowl body is stably absorbed on a plane through the suction disc at the bottom of the bowl to prevent the bowl body from being overturned by children; meanwhile, as the bowl with the suction disc is integrally formed by the silica gel, not only is a bowl material ensured to be non-toxic and harmless, but also the cost of the bowl is greatly reduced, and further the problem that the bowl is likely to break by the children is solved.

Further reference is made to CN203059154, titled “Vacuum suction bowl” by HUIZHOU DIGEXUN BABY PRODUCTS CO LTD. The invention provides a vacuum suction bowl which comprises a bowl body and a suction disk. The bowl body is arranged on the suction disk, and the suction disk is sucked on a desk top. The design realizes the purpose that when a baby learns to dine independently, the bowl cannot be turned over. Use practicability and safety are greatly improved. The vacuum suction bowl is novel in design, suction force of the suction disk is strong, the vacuum suction bowl can be separated from the desk top through the method of simply lifting one side of the suction bowl, and assembling and disassembling are convenient. Compared with the prior art, the vacuum suction bowl improves the phenomenon that a common bowl cannot be fixed on the desk top to be used, can effectively develop the good habit of baby dinning independently, enable a parent to spare hands to dine together with the baby, and therefore a harmonious and happy scene where all family members dine together is created.

Another reference is made to CN201920292 (U), titled “Bowl with suction” by RUGAO WEIYANG TEXTILE CO LTD. The invention discloses a bowl with suction, which consists of a bowl body and a base; two handles are symmetrically fixed at both sides of the bowl body; and the base is tightly fixed to the bowl bottom. In the utility model, the edge of the bowl is stabilized with the bottom so that the base is a hollow concavity and can absorb the desktop if air is sucked; the parents do not worry about burning the baby because of overturned bowl while hugging and feeding the baby; therefore, the bow with suction is safe and convenient.

A further reference is made to CN201192231 (Y), titled “Rice bowl with suction cup” by WENJIE WANG. The invention provides a rice bowl with sucking discs, which is characterized in that a plurality of sucking discs are arranged at the bottom of the rice bowl; and the rice bowl can be firmly stuck onto the desk by the sucking discs, thereby preventing a child from spilling or overturning the bowl when eating, so as to avoid contamination and waste, and prevent the child from being scalded.

Yet another reference is made to US2004231607 (A1), titled “Bowl with suction cup for pet” by E & B GIFTWARE LLC. This invention relates to a pet bowl having an interior dished portion for receiving pet food, water or the like has a rather large suction cup held centrally to the underside of the pet bowl for securing the bowl to a surface such as a floor. The pet bowl includes a sidewall extending from an upper portion to a lower portion and enclosing an open area adjacent the upper portion, with the interior dished portion sloping inwardly from the upper portion of the sidewall. A bottom wall extends beneath the dished portion and the suction cup is held beneath a central portion of the bottom wall to secure the pet bowl to a support surface to hold the pet bowl in place as a pet consumes material within the dished portion. The central portion of the bottom wall is domed shape to conform generally to the contours of the suction cup. The surface of the suction cup preferably has upstanding portions to engage the under-surface of the bottom portion to depress the suction cup assuredly upon downward movement of the bowl, and is held to the central portion of the bottom wall by a knob press-fitted into a central opening. Further, a tab may extend from the rim portion of the suction cup to be accessed through an opening in the sidewall of the pet bowl for enabling the rim of the suction cup to be lifted to release the suction cup from the support.

Another reference is made to US2002162511 (A1), titled “Pet bowl with suction cup” by E & B GIFTWARE LLC. This invention relates to a pet bowl having an interior dished portion for receiving pet food, water or the like has a rather large suction cup held centrally to the underside of the pet bowl for securing the bowl to a surface such as a floor. The suction cup underlies at least a major portion of the lateral extent of the dished portion of the bowl, and may be held removably to the pet bowl by a bracket. The surface of the suction cup preferably has upstanding portions to engage the under-surface of the bracket to depress the suction cup assuredly upon downward movement of the bowl. The bracket may have a keyed opening, and a knob with an enlarged end extends upwardly from the suction cup and may be fitted within the keyed opening to hold the suction cup removably to the bracket. Further, a tab may extend from the rim portion of the suction cup to be accessed through an opening in the sidewall of the pet bowl for enabling the rim of the suction cup to be lifted and release the suction cup from the floor.

Another reference is made to Application Number 201110160512.0, Application Date: 15 Jun. 2011 by Shanghai Hangtou School on “Anti-skid bowl”. The invention discloses an anti-skid bowl comprising a bowl opening, a bowl body, a bowl bottom and a suction disc, wherein the bowl bottom is concave; the suction disc is fixed on the surface of the bowl bottom; and the surface of the suction end of the suction disc is at a same horizontal plane with the bowl bottom. When being used or showed, the bowl can be fixed at a certain place and is difficult to be knocked off to injure other people. The anti-skid bowl disclosed by the invention is simple in structure, energy-saving, safe and practical.

Another reference is made to Application Number 02253143, Application Date: 3 May 2002, by E & B GIFTWARE LLC, on “Pet bowl with suction cup”. This invention provides a pet bowl having an interior dished portion for receiving pet food, water or the like has a rather large suction cup held centrally to the underside of the pet bowl for securing the bowl to a surface such as a floor. The suction cup underlies at least a major portion of the lateral extent of the dished portion of the bowl, and may be held removably to the pet bowl by a bracket. The surface of the suction cup preferably has upstanding portions to engage the under-surface of the bracket to depress the suction cup assuredly upon downward movement of the bowl. The bracket may have a keyed opening, and a knob with an enlarged end extends upwardly from the suction cup and may be fitted within the keyed opening to hold the suction cup removably to the bracket. Further, a tab may extend from the rim portion of the suction cup to be accessed through an opening in the sidewall of the pet bowl for enabling the rim of the suction cup to be lifted and release the suction cup from the floor.

However, most of these inventions comprise either knobs, key-shaped slots, tabs or any other mechanism to create suction vacuum, which is complex in nature. The mechanism required to release the suction cup from the surface is also very complex. This makes these inventions very complex, costly, difficult to operate, maintain and clean and also difficult to fabricate.

### SUMMARY

Generally, a pet food bowl may include a body comprising a medial portion having an upper end defining a first cavity for receiving food or water, and a lower end opposite the upper end, and an outer wall extending from the upper end of the medial portion at a periphery of the upper end of the medial portion. The pet food bowl may comprise a flexible annular flange coupled to a distal end of the outer wall along an entire length of the outer wall. The body may include a metallic material, and the lower end of the medial portion and the outer wall may define a second cavity opposite the first cavity. The flexible annular flange may be configured to define a suction cup with the second cavity for adhering the body to a surface.

The metallic material may include stainless steel. The flexible annular flange may comprise rubber. The flexible annular flange may extend outward and away from the distal end of the outer wall. The pet food bowl may also include a flap coupled to the flexible annular flange and configured to release the suction cup. The pet food bowl as wherein the body is adhered to the surface without using fixation devices. The pet food bowl as further comprising an adhesive layer between the flexible annular flange and the distal end of the outer wall.

Another aspect is directed to a method for making a pet food bowl. The method may include forming a body comprising a medial portion having an upper end defining a first cavity for receiving food or water, and a lower end opposite the upper end, and an outer wall extending from the upper end of the medial portion at a periphery of the upper end of the medial portion. The forming may comprise stamping a stainless steel sheet, cutting and trimming edges of a stamped stainless steel piece, rolling the edges to remove any sharpness, and polishing the stamped stainless steel piece using a buffing machine. The method may include forming an adhesive layer for coupling a flexible annular flange to a distal end of the outer wall along an entire length of the outer wall, and heating the stamped stainless steel piece to bond the flexible annular flange to the distal end of the outer wall. The lower end of the medial portion and the outer wall may define a second cavity opposite the first cavity, and the flexible annular flange configured to define a suction cup with the second cavity for adhering the body to a surface.

### BRIEF DESCRIPTION OF THE DRAWINGS

FIG. 1 is a schematic diagram of a pet food bowl, according to the present disclosure.

FIGS. 2-5 are schematic diagrams of varying views of an example embodiment of the pet food bowl, according to the present disclosure.

### DETAILED DESCRIPTION

The present invention does not involve any such complex features and is very easy to manufacture and use, and is still very effective. The suction system provides very strong immovable features in the bowl so that without using any screws or any external systems, the bowl is strongly held at the ground or any other flat surface when placed. This makes the bowl immovable without adding any complexity or additional costing.

The present invention relates to the field of pet bowls. More particularly, the present invention relates to an immovable pet bowl. Even more particularly, the present invention relates to a stainless-steel suction pet bowl. The present invention provides pet bowl with suction system in which once fixed to ground or any flat surface, the bowl remains fixed there. The present invention also provides a method of fabricating such stainless-steel suction pet bowl.

### OBJECTS OF THE INVENTION

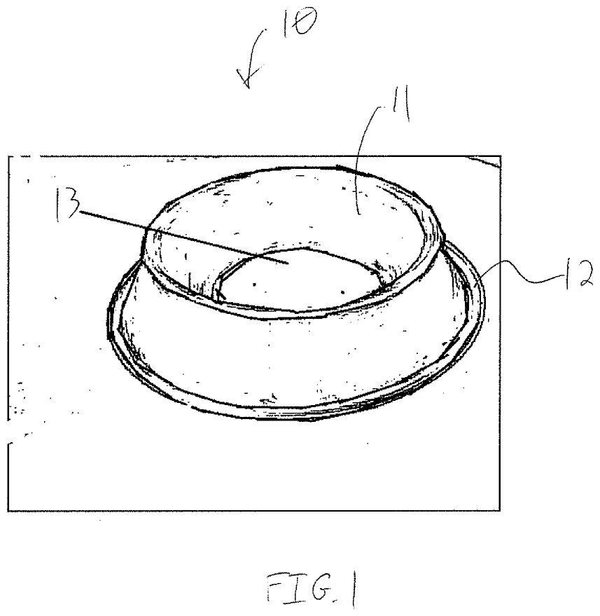

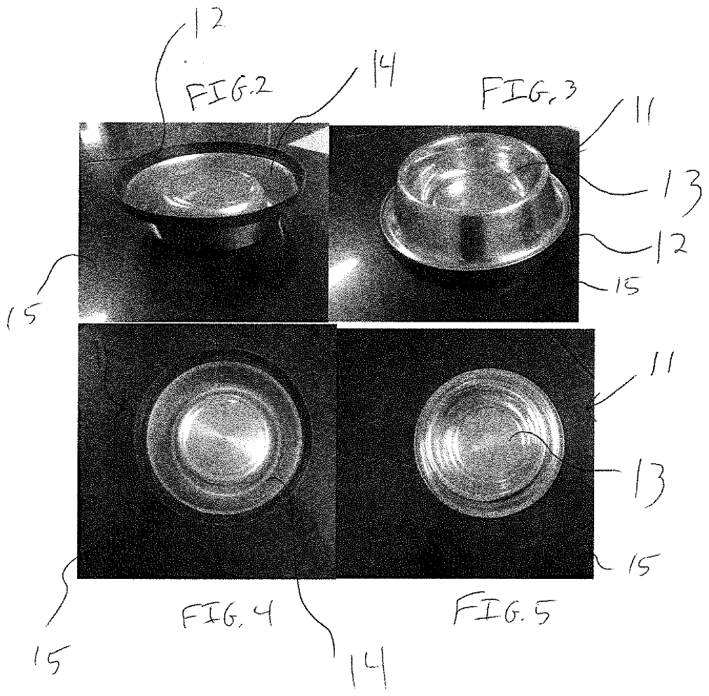

Referring to FIGS. 1-5, a pet food bowl 10 according to the present disclosure is now described. The pet food bowl 10 illustratively includes a body 11 comprising a medial portion having an upper end defining a first cavity 13 for receiving food or water, and a lower end opposite the upper end, and an outer wall extending from the upper end of the medial portion at a periphery of the upper end of the medial portion. The pet food bowl 10 illustratively includes a flexible annular flange 12 coupled to a distal end of the outer wall along an entire length of the outer wall. The body 11 illustratively includes a metallic material, and the lower end of the medial portion and the outer wall defines a second cavity 14 opposite the first cavity. The flexible annular flange 12 is configured to define a suction cup with the second cavity 14 for adhering the body 11 to a surface 15.

The metallic material may include stainless steel. The flexible annular flange may comprise rubber. The flexible annular flange may extend outward and away from the distal end of the outer wall. The pet food bowl may also include a flap coupled to the flexible annular flange and configured to release the suction cup. The pet food bowl as wherein the body is adhered to the surface without using fixation devices. The pet food bowl as further comprising an adhesive layer between the flexible annular flange and the distal end of the outer wall.

Another aspect is directed to a method for making a pet food bowl. The method may include forming a body comprising a medial portion having an upper end defining a first cavity for receiving food or water, and a lower end opposite the upper end, and an outer wall extending from the upper end of the medial portion at a periphery of the upper end of the medial portion. The forming may comprise stamping a stainless steel sheet, cutting and trimming edges of a stamped stainless steel piece, rolling the edges to remove any sharpness, and polishing the stamped stainless steel piece using a buffing machine. The method may include forming an adhesive layer for coupling a flexible annular flange to a distal end of the outer wall along an entire length of the outer wall, and heating the stamped stainless steel piece to bond the flexible annular flange to the distal end of the outer wall. The lower end of the medial portion and the outer wall may define a second cavity opposite the first cavity, and the flexible annular flange configured to define a suction cup with the second cavity for adhering the body to a surface.

The main objective of this invention is to provide a pet bowl. Another objective of the invention is to provide a pet bowl which is immovable by pet, once fixed in place. A further objective of the invention is to provide a stainless-steel pet bowl which has suction feature in-built to make the bowl immovable. Another objective of the invention is to provide a stainless-steel bowl with a rubber ring permanently attached to the lower side of bowl to create suction system, when placed on ground or any other flat surface. Another objective of the invention is to provide a method of fabrication of immovable stainless-steel suction pet bowl.

The present invention provides a pet bowl which is immovable by pet, once fixed in place. The invention provides a stainless-steel pet bowl, which has suction feature in-built to make the bowl immovable. There is a rubber ring permanently attached to the lower side of bowl to create suction system, when placed on ground or any other flat surface. The invention also provides a method of fabrication of immovable stainless-steel suction pet bowl.

Accordingly, the present invention provides a suction vacuum based bowl and a method of fabricating thereof, the bowl comprising an outer wall and an anti-skid bottom, bowl having a central hollow upper side cavity for keeping food or water, the bowl is made up of a metal and is round in shape, the entire circumference of the bottom of the bowl is permanently bonded to a non-skid material over bottom edge in one layer, and central portion of the bottom is left un-covered, such that when kept on a surface, another cavity is created on the bottom side which creates vacuum inside the layer of non-skid material at the bottom edge thus making the bowl immovable and affixed to the surface.

It should be noted that the particular description and embodiments set forth in the specification below are merely exemplary of the wide variety and arrangement of instructions which can be employed with the present invention. The present invention may be embodied in other specific forms without departing from the spirit or essential characteristics thereof. All the features disclosed in this specification may be replaced by similar other or alternative features performing similar or same or equivalent purposes. Thus, unless expressly stated otherwise, they all are within the scope of present invention. Various modifications or substitutions are also possible without departing from the scope or spirit of the present invention. Therefore, it is to be understood that this specification has been described by way of the most preferred embodiments and for the purposes of illustration and not limitation.

The present invention provides an immovable pet bowl, which cannot be moved by pet once fixed in place. Therefore, the present invention provides a pet bowl that may be placed on a surface such as a floor and better held in place during use. The present invention provides a pet bowl or dish with a feature of suction at the bottom so that the bowl once fixed, does not move from the surface. The suction feature is able to fix the bowl centrally at any flat surface, such as a floor.

The invention provides a stainless-steel pet bowl for holding material to be consumed by a pet, which could be a food item or liquid/water. The suction pet bowl of present invention has a bowl held centrally by means to create vacuum/suction at the bottom of bowl from outside. The stainless-steel suction bowl has this feature which enables bowl to be secured to a flat surface to hold the pet bowl in place such that as a pet consumes material from the bowl, the bowl does not move and is securely held in place without any external means like screws, nuts etc. The stainless-steel bowl has a rubber ring at the bottom which when pressed on the flat surface, creates a suction in the open space under and so the bowl becomes immovable.

Therefore, the suction vacuum bowl of present invention is immovable. The bowl comprises an outer wall and an anti-skid bottom. The outer wall forms a central hollow upper side cavity which is used for keeping food or water. The bowl is made up of a metal, which is preferably stainless-steel and is round in shape.

The entire circumference of the bottom of the bowl is permanently bonded to a non-skid material over bottom edge in one layer, and central portion of the bottom is left un-covered, such that when kept on a surface, another cavity is created on the bottom side which creates vacuum inside the layer of non-skid material at the bottom edge thus making the bowl immovable and affixed to the surface. The anti-skid material is preferably rubber.

The bowl is having an extra layer of rubber left outside the flange at bottom circumference with rubber permanently bonded to the bottom, so that no air is passed through at any other point and very strong suction effect is created when in use. This point is very important as if air keeps on crossing, then a sufficiently strong suction effect will not be created and bowl will not be immovable. So this innovative feature of making rubber permanently bonded and leaving an extra layer together generate the desired suction vacuum effect and make the bowl completely immovable.

Further the bowl comprises a small rounded flap in rubber portion extended at the bottom so as to release the suction when required. This is also very innovative feature as the suction effect is so strong that entire bowl cannot be pushed or moved after placing. So, a small flap is added to release the vacuum when bowl needs to be moved.

The bowl is held centrally by means of vacuum/suction at the bottom of bowl. The bowl can be any household bowl or a pet bowl. When used as a pet bowl, this is completely immovable when kept on any kind of surface even while being used by pet. The pet can easily consume food or water and the bowl shall not move/topple by normal activity of pet while being used.

The suction vacuum bowl is immovable by simple yet effective mechanism and does not require any means like screws, nuts etc. to hold it in place or to create vacuum. This makes the bowl cost-effective in fabricating as compared to other known suction bowls in prior art. The bowl is easy to clean and maintain also as no external or additional components are present which need cleaning. It is very simple yet very strong and effective mechanism.

The vacuum/suction is created in the bowl by simply pressing the bowl on any surface such that vacuum is created in the hollow/open space under anti-skid bottom which makes the bowl immovable. All materials used are food grade materials so the food or water even if stored for longer duration does not get adversely effected by bowl materials. The bowl is completely rust proof. No screws or nuts are required. The quality is very durable and the entire bowl is completely dish-washer safe.

The method of fabricating stainless-steel Suction dog bowl comprises the following steps:

Stainless-steel Suction Dog Bowl fabricating steps:

1. Stainless Steel pet bowl is made by stamping process on Hydraulic or any other stamping machines for stainless steel.

2. After stamping the bowl the edges of stainless steel bowl are cut and trimmed with the help of cutting and trimming machine for making the outer edge even on all sides.

3. After even edged the edges are rolled, so the edges are not sharp, to avoid any accidents.

4. Bowl is polished with the help of buffing machine, for giving shiny or matt surface.

5. The bottom flange of the stainless-steel bowl is glued.

6. After gluing the bowl is again placed on the hydraulic machine with heaters, wherein the mold is heated ranging from 150 degree to 300 degree depending on the rubberized material used.

7. The rubber material gets melted due on the heated mold and with the heat, glue and pressure the rubber is permanently bonded with stainless steel bowl.

8. Extra rubber outside the flange is left to create the suction, as without the extra rubber the suction cannot be created, in fact the permanent bonding of rubber is also necessary in this bowl for creating the suction else if the air passes through from any point the vacuum cannot be created, and this will release the suction. A rounded small flap is also extended on the rubber to release the suction.

The method for fabricating stainless steel bowl comprises the following steps:

1. Stainless Steel pet bowl is made by stamping process on Hydraulic or any other stamping machines for stainless steel.

2. After stamping the bowl the edges of stainless steel bowl are cut and trimmed with the help of cutting and trimming machine for making the outer edge even on all sides.

3. After even edged the edges are rolled, so the edges are not sharp, to avoid any accidents.

4. Bowl is polished with the help of buffing machine, for giving shiny or matt surface.

5. The Round rubber ring is produced with the help injection molding machine.

6. The rubber ring is bonded permanently with the help of glue.

So accordingly, the present invention provides A suction vacuum based bowl and a method of fabricating thereof, the bowl comprising an outer wall and an anti-skid bottom, bowl having a central hollow upper side cavity for keeping food or water, the bowl is made up of a metal and is round in shape, the entire circumference of the bottom of the bowl is permanently bonded to a non-skid material over bottom edge in one layer, and central portion of the bottom is left un-covered, such that when kept on a surface, another cavity is created on the bottom side which creates vacuum inside the layer of non-skid material at the bottom edge thus making the bowl immovable and affixed to the surface.

In an embodiment, the metal is preferably stainless steel. In another embodiment, the anti-skid material is preferably rubber. In another embodiment, the bowl comprises leaving extra layer of rubber outside the flange at bottom circumference with rubber permanently bonded to bottom, so that no air is passed through at any other point and very strong suction effect is created when in use. In another embodiment, the bowl comprises a small rounded flap in rubber portion extended at the bottom so as to release the suction when required.

In another embodiment, the bowl is held centrally by means of vacuum/suction at the bottom of bowl. In another embodiment, the bowl is a pet bowl. In another embodiment, the bowl is immovable when kept on any kind of surface even while being used by pet. In another embodiment, the bowl is immovable by simple yet effective mechanism and does not require any means like screws, nuts etc. to hold it in place or to create vacuum. In another embodiment, the vacuum/suction is created in the bowl by simply pressing the bowl on any surface such that vacuum is created in the hollow/open space under anti-skid bottom which makes the bowl immovable.

In another embodiment, the method of fabricating suction dog bowl comprises the steps of:

fabricating stainless steel pet bowl by stamping process on hydraulic or any other stamping machines;
cutting the edges of stainless steel bow after stamping the bowl and trimming with the help of cutting and trimming machine for making the outer edge even on all sides;
rolling the edges to remove any sharpness;
polishing the bowl with the help of buffing machine;
gluing the bottom flange of the stainless-steel bowl;
placing bowl again on the hydraulic machine with heaters, to heat the mold from 150 degree to 300 degree depending on the rubberized material used to melt the rubber material so that with heat, pressure and glue, the rubber is permanently bonded with stainless steel bowl; leaving extra rubber outside flanges to create suction and leaving a small rounded flap to remove the bowl from suction when required.

### Advantages of the Invention

Anti-skid and very strong immovable grip on ground or any other flat surface when placed, such that it does not move with normal pet activity

Easy to handle and clean
Food grade materials

### Rust Proof

No screws required
No complex features to make it immovable
Durable quality
Dish-washer safe

1-12. (canceled)

13. A pet food bowl comprising:
a body comprising
a medial portion having an upper end defining a first cavity for receiving food or water, and a lower end opposite said upper end, and
an outer wall extending from said upper end of said medial portion at a periphery of said upper end of said medial portion; and
a flexible annular flange coupled to a distal end of said outer wall along an entire length of said outer wall;
said body comprising a metallic material;
said lower end of said medial portion and said outer wall defining a second cavity opposite said first cavity;
said flexible annular flange configured to define a suction cup with the second cavity for adhering said body to a surface.

14. The pet food bowl as in claim 13 wherein said metallic material comprises stainless steel.

15. The pet food bowl as in claim 13 wherein said flexible annular flange comprises rubber.

16. The pet food bowl as in claim 13 wherein said flexible annular flange extends outward and away from said distal end of said outer wall.

17. The pet food bowl as in claim 13 further comprising a flap coupled to said flexible annular flange and configured to release the suction cup.

18. The pet food bowl as in claim 13 wherein said body is adhered to the surface without using fixation devices.

19. The pet food bowl as in claim 13 further comprising an adhesive layer between said flexible annular flange and said distal end of said outer wall.

20. A method for making a pet food bowl, the method comprising:
forming a body comprising
a medial portion having an upper end defining a first cavity for receiving food or water, and a lower end opposite the upper end, and
an outer wall extending from the upper end of the medial portion at a periphery of the upper end of the medial portion; and
coupling a flexible annular flange to a distal end of the outer wall along an entire length of the outer wall;
the body comprising a metallic material;
the lower end of the medial portion and the outer wall defining a second cavity opposite the first cavity;
the flexible annular flange configured to define a suction cup with the second cavity for adhering the body to a surface.

21. The method as in claim 20 wherein the metallic material comprises stainless steel.

22. The method as in claim 20 wherein the flexible annular flange comprises rubber.

23. The method as in claim 20 wherein the flexible annular flange extends outward and away from the distal end of the outer wall.

24. The method as in claim 20 further comprising forming a flap coupled to the flexible annular flange and configured to release the suction cup.

25. The method as in claim 20 wherein the body is adhered to the surface without using fixation devices.

26. The method as in claim 20 further comprising forming an adhesive layer between the flexible annular flange and the distal end of the outer wall.

27. A method for making a pet food bowl, the method comprising:
forming a body comprising
a medial portion having an upper end defining a first cavity for receiving food or water, and a lower end opposite the upper end, and
an outer wall extending from the upper end of the medial portion at a periphery of the upper end of the medial portion;
the forming comprising
stamping a stainless steel sheet,
cutting and trimming edges of a stamped stainless steel piece,
rolling the edges to remove any sharpness, and
polishing the stamped stainless steel piece using a buffing machine;
forming an adhesive layer for coupling a flexible annular flange to a distal end of the outer wall along an entire length of the outer wall; and
heating the stamped stainless steel piece to bond the flexible annular flange to the distal end of the outer wall;
the lower end of the medial portion and the outer wall defining a second cavity opposite the first cavity;
the flexible annular flange configured to define a suction cup with the second cavity for adhering the body to a surface.

28. The method as in claim 27 wherein the flexible annular flange comprises rubber.

29. The method as in claim 27 wherein the flexible annular flange extends outward and away from the distal end of the outer wall.

30. The method as in claim 27 further comprising forming a flap coupled to the flexible annular flange and configured to release the suction cup.

31. The method as in claim 27 wherein the body is adhered to the surface without using fixation devices.
